(19) United States
(12) Patent Application Publication
(10) Pub. No.: US 2008/0314094 A1
(43) Pub. Date: Dec. 25, 2008

(54) Cable lock

(75) Inventor: Chang Chin Shu, Changhua City (TW)

Correspondence Address: TROXELL LAW OFFICE PLLC, 5205 LEESBURG PIKE, SUITE 1404, FALLS CHURCH, VA, 22041, US

(73) Assignee: VULCAN SPORTS CO., LTD.

(21) Appl. No.: 11/812,980

(22) Filed: Jun. 22, 2007

(51) Int. Cl. E05B 37/02

(52) U.S. Cl. 70/30

(57) ABSTRACT

An improved cable lock that can adjust the length of a steel cable to snugly wind a target locking article mainly has a shell to house a winding means, a release means and a locking means. The steel cable has one end fastened to a latch head which can be inserted into the locking means. After the latch head is inserted and latched, the steel cable can still be retracted so that it can wind the targeted locking article snugly to facilitate operation of the cable lock.

### BACKGROUND OF THE INVENTION

1. Field of the Invention

The present invention relates to a cable lock that has a steel cable fastened to a latch head which is latchable to a locking means and a release means to allow the steel cable to be retracted before being latched by a locking means so that the steel cable can wind around a targeted locking article snugly to facilitate operation of the cable lock.

2. Description of the Prior Art

Cable locks have many advantages such as light and portable and easy to store, thus are widely used for theft-prevention for various types of goods such as bicycles, displaying commodities, notebook computers and the like. A great deal of developments also have been invested on cable locks. Reference can be found in Taiwan patent publication Nos. 568150, 568158, 261189, 451997, 517768, M246413, M255441, M259041, M282013, M284737 and M284925. They mostly have a cable head to provide theft-prevention effect for various types of goods, and generally have some practical value. However, they still have drawbacks. A conventional cable lock, referring to FIG. 8, has a steel cable 91 which can be pulled out for a desired length to wind around a targeted locking article, then a latch head 92 of the steel cable 91 is inserted into a latch orifice 93 of the cable lock 9 to be latched by a locking means 94 to achieve the object of theft-prevention. Once the latch head 92 is inserted into the latch orifice 93, it presses a release bar 95 to prevent a pushbutton 96 from being depressed. The cable length cannot be adjusted unless unlocking is done again. Hence it is not convenient to use. Moreover the steel cable 91 could be pulled out too long and result in winding the targeted locking article too loosely. There are still rooms for improvement.

### SUMMARY OF THE INVENTION

In view of the aforesaid problems, the present invention aims to provide an improved cable lock that can adjust the length of the steel cable to fit a targeted locking article. The steel cable has a latch head which can be inserted into a locking means. Before locking of the locking means the steel cable can still be retracted to make the steel cable to wind around the targeted locking article more snugly. Operation of the cable lock is more convenient. The invention mainly includes a shell which houses a winding means, a release means and a locking means. By means of these elements the steel cable can be adjusted to make operation simpler and easier.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a sectional view of the invention in an assembled condition.

FIG. 3 is a sectional view of the invention.

FIG. 4 is a sectional view of the invention for adjusting the steel cable.

FIG. 5 is another sectional view of the invention for adjusting the steel cable.

FIG. 6 is a schematic view of an embodiment of the invention by coupling with a bicycle

FIG. 7 is a schematic view of an embodiment of the invention to be coupled with a holding dock.

FIG. 8 is a sectional view of a conventional cable lock.

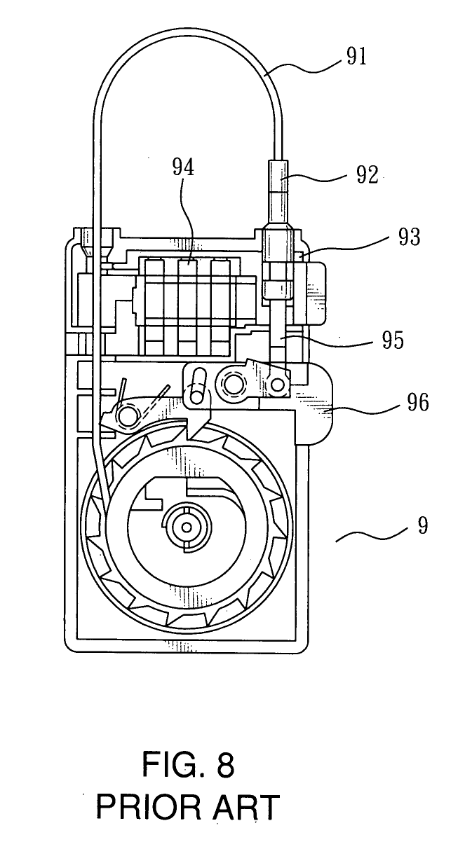

### DESCRIPTION OF THE PREFERRED EMBODIMENTS

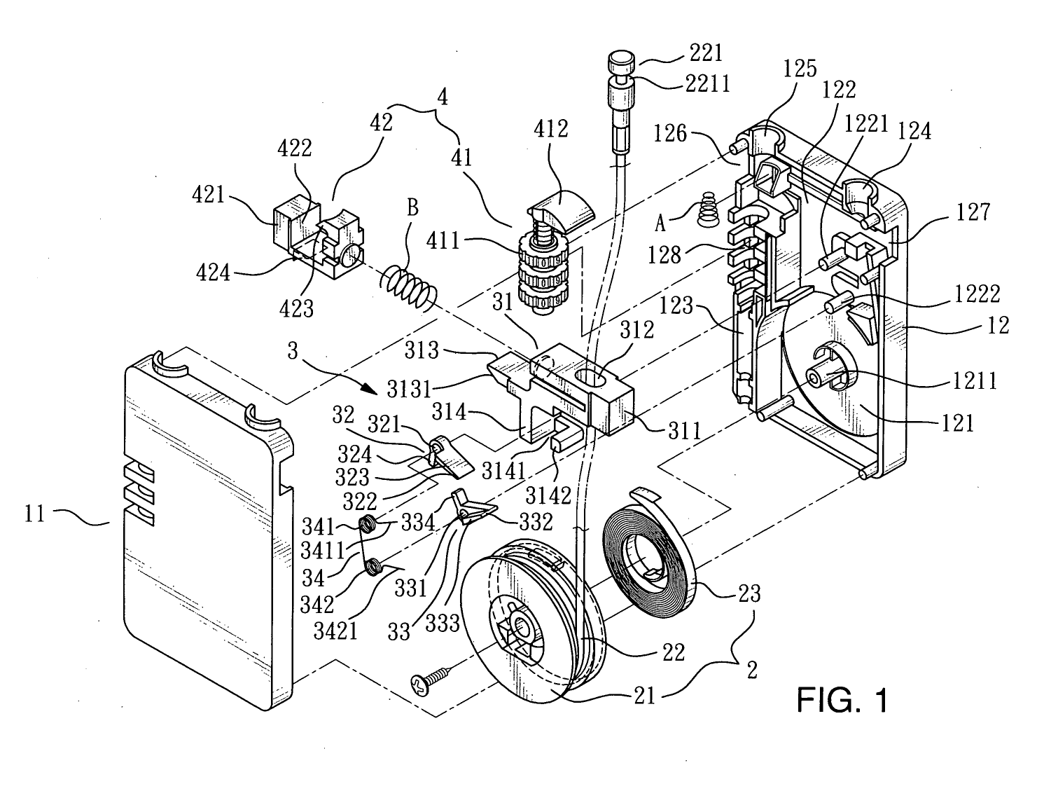

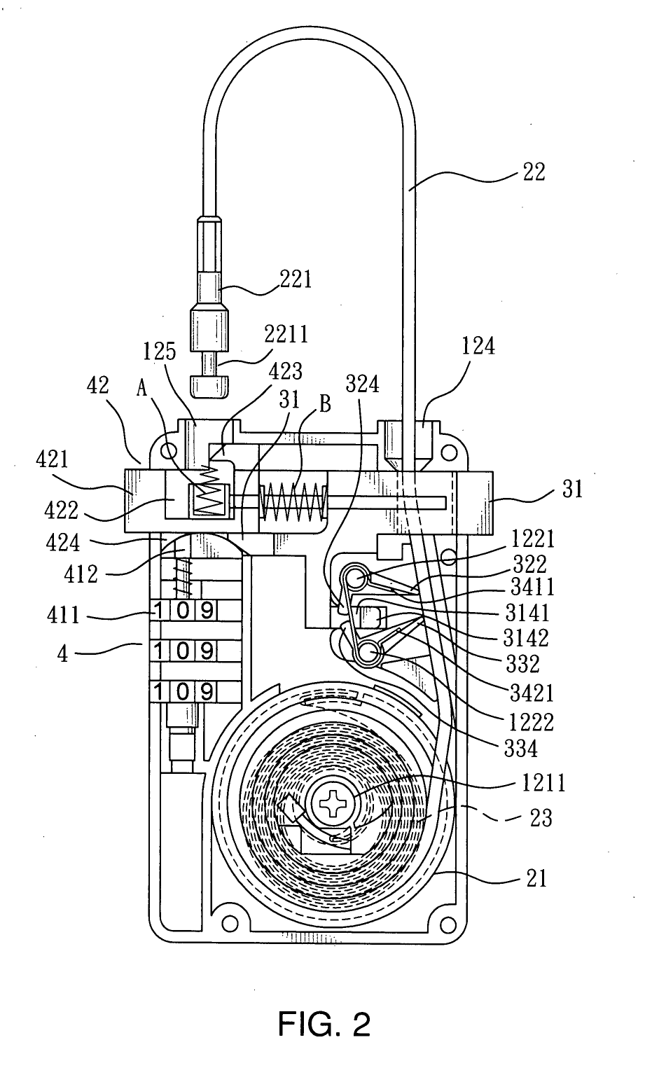

Referring to FIGS. 1 and 2, the cable lock according to the invention has a shell 1 which houses a winding means 2, a release means 3 and a locking means 4.

The shell 1 includes a upper shell 11 and a lower shell 12 that are fastened together. It has a first housing chamber 121, a second housing chamber 122 and a third housing chamber 123. The shell 1 further has a spring holding strut 1211 and a plurality of anchor struts 1221 and 1222. At the upper side of the shell 1 there are a steel cable release orifice 124 and a latch orifice 125. The latch orifice 125 holds an elastic element A. The shell 1 also has a first push hole 126 and a second push hole 127 at two sides. Beneath the first push hole 126 there are a plurality of number display openings 128.

The winding means 2 is held in the first housing chamber 121, and has a winding wheel 21 to wind a steel cable 22 that is coupled with a spring 23. The spring 23 has one end fastened to the spring holding strut 1211. The steel cable 22 has a distal end fastened to a latch head 221 which is extended outside the shell 1. The steel cable can be pulled out through the steel cable release orifice 124 to drive the winding wheel 21 and turn the spring 23 to generate power to automatically retract the steel cable 22.

The release means 3 is located in the second housing chamber 122, and includes:

a first control bar 31 which has a first depressing portion 311 at one end and an aperture 312 to be threaded through by the steel cable 22 and another end pushed by an elastic element B in normal conditions so that the first depressing portion 311 is extended outside the shell 1 through the second push hole 127 in the normal conditions that is depressible by users. The first control bar 31 is extended downwards to form a second end 314 which has a distal end forming a hook notch 2141 and a hook 3142. The first control bar 31 further is extended rearwards to form a third end 313 which has a distal end forming a slant surface 3131;

a first release bar 32 which has a latch hole 321 to couple with the anchor strut 1221 in the second housing chamber 122 and is located at one side of the hook notch 3141. The first release bar 32 has a long stem 322 which has a distal end pressing the steel cable 22 and a jutting detent wall 323 at one side and a short stem 324 at another side located transversely in the hook notch 3141 of the first control bar 31;

a second release bar 33 which is corresponding to the first release bar 32 and has a latch hole 331 to couple with another anchor strut 1222 in the second housing chamber 122, and is located at one side of the hook notch 3141. The second release bar 32 has a long stem 332 which has a distal end pressing the steel cable 22 and a jutting detent wall 333 at one side, and a short stem 334 at another side located transversely in the hook notch 3141 of the first control bar 31; and

a torsional element 34 which has two ends forming respectively a helical hole 341 and 342 to couple with the anchor struts 1221 and 1222, and have two tail ends 3411 and 3421 to press respectively the detent walls 323 and 333 to push the long stems 322 and 332 of the first and second release bars 32 and 33 outwards to press the steel cable 22 in the normal conditions.

The locking means 4 is located in the third housing chamber 123, and includes:

a combination lock 41 which is a standard element and has at least a plurality of dial wheels 411 and a latch bolt 412. The dial wheels 411 have one side corresponding to the number display openings 128 to facilitate user dialing operation; and

a second control bar 42 which has a second depressing portion 421 at one end extending outside through the first push hole 126 to be depressed by users, and another end forming a hook 423 and a holding opening 422. The hook 423 is latchable with a neck 2211 formed on the latch head 221 and is pushed by the elastic element B so that the second depressing portion 421 is extended outside the shell 1 in the normal conditions. The second control bar 42 also has the bottom forming a jutting diagonal angle 424.

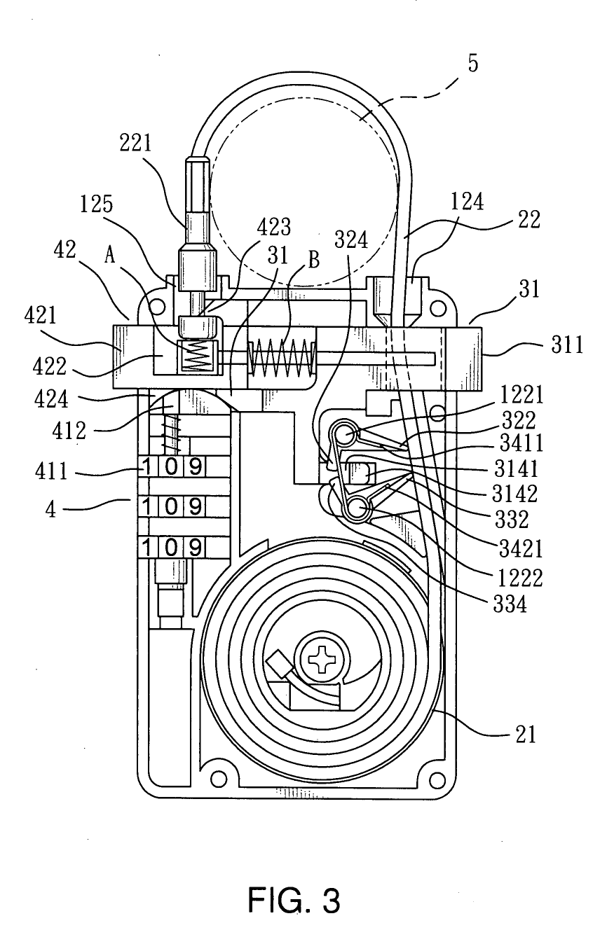

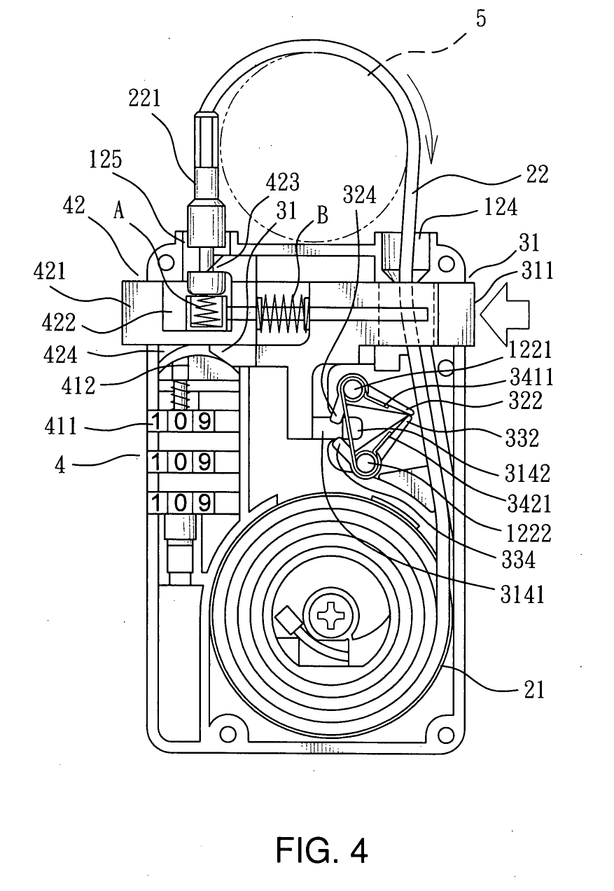

By means of the elements set fort above, referring to FIGS. 2, 3 and 4, when in use for locking a targeted locking article 5, and the locking means 4 is not yet in a locking condition (namely the numbers of the combination lock 41 are in a unlocking condition), the latch bolt 412 is pushed inwards. Users have to depress the first depressing portion 311 of the first control bar 31 to push the first control bar 31 rearwards (when the locking means 4 is in the unlocking condition, the latch bolt 412 is pushed by the third end 313 of the first control bar 31 and withdrawn without hindering the rearward movement of the first control bar 31), hence the first control bar 31 pushes the elastic element B and the hook 3142 of the second end 314 to form a latch condition to pull the short stems 324 and 334 of the first and second release bars 32 and 33, and the first and second release bars 32 and 33 turn about the anchor struts 1221 and 1222 to withdraw the long stems 322 and 332, and compress the two tails ends 3411 and 3421. The release means 3 no longer harnesses the steel cable 22, hence a user can pull out the steel cable 22 outside the shell 1 through the latch head 221 and the steel cable release orifice 124 for a desired length. Then the user can release the first depressing portion 311 of the first control bar 31. The first control bar 31 is pushed by the elastic element B and the latch bolt 42 and returns to make the first depressing portion 311 to be extended outside the shell 1 again in the normal conditions. The first and second release bars 32 and 33 receive the returning elastic force of the torsional element 34 so that the long stems 322 and 332 are moved outwards to press the steel cable 22 to prohibit it from releasing or withdrawing. After the targeted locking article 5 has been wound around by the steel cable 22, insert the latch head 221 of the steel cable 22 into the latch orifice 125 of the shell 1 to compress the elastic element A held in the latch orifice 125 and the hook 423 of the second control bar 42, the second control bar 42 pushes the elastic element B and the diagonal angle 424 at the bottom to press the latch bolt 412 to retract inwards without hindering the movement of the second control bar 42. After the latch head 221 is held in the holding opening 422 of the second control bar 42, the hook 423 latches the neck 2211 of the latch head 221 to prevent it from escaping. At this moment the user can inspect whether the pulled out steel cable 22 is too long. If the length is too long, he/she can depress the first depressing portion 311 of the first control bar 31 again. The spring 23 of the winding means 2 retracts the steel cable 22 to wind around the targeted locking article 5 more snugly. Then the first control bar 31 can be released. The movements of the release means 3 are same as previously discussed, details are omitted. After the length of the steel cable 22 has been adjusted, the locking action of the locking means 4 can be started. This can be accomplished by dialing the dial wheels 411 at a random number. After the locking condition of the locking means 4 is accomplished, the latch bolt 412 cannot be moved downwards, and the first and second control bars 41 and 42 are latched and cannot be retracted. Thus a locking condition is achieved.

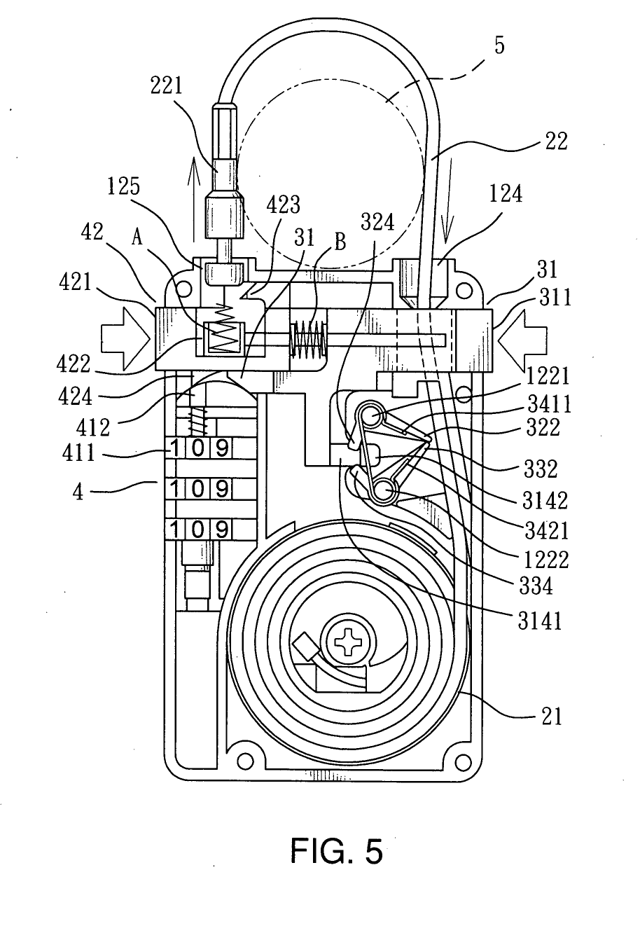

Referring to FIG. 5, to do unlocking, first dial the dial wheels 411 according to the correct unlocking numbers; push the second depressing portion 421 of the second control bar 42 to retract the hook 423; when the second control bar 42 is moved rearwards the diagonal angle 424 also depresses the latch bolt 412 so that the hook 423 escapes the neck 2211 of the latch head 221 and is pushed by the returning elastic force of the elastic element A at the bottom of the latch orifice 125; the latch head 221 is moved away from the latch orifice 125; and unlocking is accomplished. Depress the first depressing portion 311 of the first control bar 31 again; the steel cable 22 can be retracted. Operation is same as previously discussed.

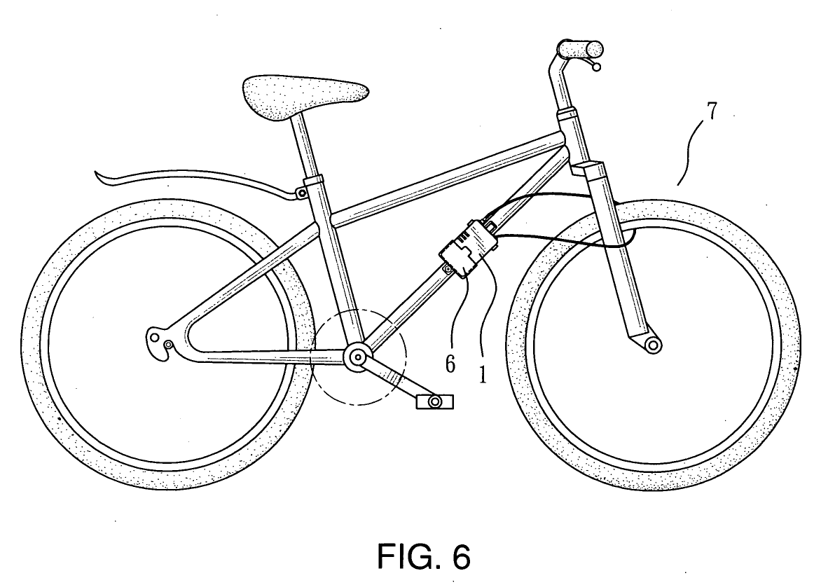

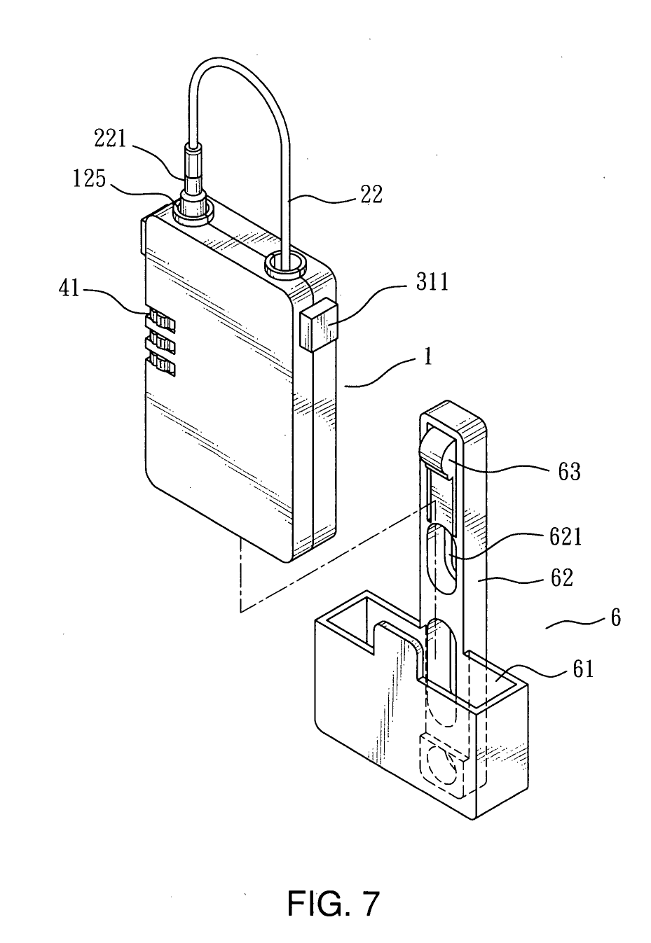

Refer to FIGS. 6 and 7 for an embodiment of the invention used on a bicycle. To facilitate carrying, a holding dock 6 is provided that includes at least a holding trough 61 to hold the invention. There is a post 62 extended upwards from one side of the holding trough 61. The post 62 has at least one latch aperture 621 to be fastened to a bicycle 7. The post 62 has a distal end coupling with an elastic clip 63 to latch the invention and prevent it from escaping because of shaking during riding of the bicycle.

In short, when the invention is in use and the latch head of the steel cable has been latched, the steel cable can still be retracted to form a fitted winding on the targeted locking article. Operation is simple and easy. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A cable lock comprising a shell to house a winding means, a release means and a locking means; wherein:
the shell includes a upper shell and a lower shell, a steel cable release orifice and a latch orifice at a upper side, a first push hole and a second push hole at two sides, and a plurality of number display openings below the first push hole;
the winding means is held in the shell and includes a winding wheel to wind the steel cable and a spring, the steel cable having a distal end fastening to a latch head;
the release means is located in the shell and includes:
a first control bar which has one end forming a first depressing portion that is extended outside the shell through the second push hole, and is extended downwards to form a second end which has a distal end forming a hook notch and a hook, and extended rearwards to form a third end;
a first release bar which has a first long stem and a first short stem transversely located in the hook notch of the first control bar, the first long stem having a first distal end pressing the steel cable and a jutting first detent wall formed at one side;
a second release bar which is corresponding to the first release bar and has a second long stem and a second short stem transversely located in the hook notch of the first control bar, the second long stem having a second distal end pressing the steel cable and a jutting second detent wall formed at one side; and
a torsional element which has two ends pushing the long stems of the first and second release bars; and
the locking means is located in the shell and includes.
a combination lock which has at least a plurality of dial wheels and a latch bolt, the dial wheels having one side corresponding to the number display openings of the shell; and
a second control bar which has one end forming a second depressing portion extended outside the shell through the first push hole and another end forming a hook and a holding opening.

2. The cable lock of claim 1, wherein the third end of the first control bar has a distal end forming a slant surface.

3. The cable locks of claim 1, wherein the second control bar has a jutting diagonal angle at the bottom thereof.
